(19) United States
(12) Patent Application Publication
(10) Pub. No.: US 2006/0186260 A1
(43) Pub. Date: Aug. 24, 2006

(54) Method of inspecting aircraft

(75) Inventors: Gregory A. Magnuson, Tulsa, OK (US); Parker J. Doughty, Broken Arrow, OK (US)

Correspondence Address: WINSTEAD SECHREST & MINICK P.C., PO BOX 50784, DALLAS, TX, 75201, US

(73) Assignee: American Airlines, Inc., Dallas, TX (US)

(21) Appl. No.: 11/061,077

(22) Filed: Feb. 18, 2005

(51) Int. Cl. B64D 45/00

(52) U.S. Cl. 244/1 R

(57) ABSTRACT

A method of inspecting aircraft for evidence of stress fracture and other external abnormalities comprising: (a) identifying an aircraft surface to be inspected; (b) determining if the surface to be inspected is visually impeded by a coating compound selected from the group of compounds including paint, topcoats, and primers; (c) if present removing all visually impeding compounds identified in (b); (d) inspect the aircraft surface identified in (a); (e) identify and procure adhesive tape patch with properties generally consistent to those demonstrated in 3M product 8681 HS Polyurethane Protective Tape; and, (f) applying the adhesive patch of (e) over the inspected aircraft surface.

### CROSS REFERENCE

This application is not related to any pending application.

### STATEMENT OF FEDERALLY SPONSORED RESEARCH/DEVELOPMENT REFERENCES TO SEQUENCE LISTING

This application is not referenced to any microfiche appendix.

### BACKGROUND OF THE INVENTION

The need for repetitive inspection of aircraft surfaces is often required as a consequence of an airworthiness directive issued by the Federal Aviation Authority (FAA). Such airworthiness directives typically cite an immediate or emergency concern resulting from one or more instances in which stress fractures or other damage to airplane surfaces have been observed, often with serious consequences associated therewith. A non-limiting example of an airworthiness directive is provided immediately below to acquaint the reader with related rules associated with the issuance of these directives as well as the specific remedial action to be taken.

This amendment adopts a new airworthiness directive (AD) that is applicable to certain McDonnell Douglas Model DC-9-81 (MD-81), DC-9-82 (MD-82), DC-9-83 (MD-83), and DC-9-87 (MD-87) airplanes; Model MD-88 airplanes, and Model MD-90-30 airplanes. This action requires repetitive inspections to detect cracking of the shock strut cylinders of the left and right main landing gears (MLG), and replacement of any cracked shock strut cylinder. This action is necessary to prevent failure of the shock strut cylinders of the MLGs due to cracking, which could result in collapse of the MLGs and consequent reduced controllability during landing. This action is intended to address the identified unsafe condition.

Dates: Effective Mar. 15, 2004.

The incorporation by reference of certain publications listed in the regulations is approved by the Director of the Federal Register as of Mar. 15, 2004.

Comments for inclusion in the Rules Docket must be received on or before Apr. 27, 2004.

ADDRESSES: Submit comments in triplicate to the Federal Aviation Administration (FAA), Transport Airplane Directorate, ANM-114, Attention: Rules Docket No. 2003-NM-122-AD, 1601 Lind Avenue, SW., Renton, Wash. 98055-4056. Comments may be inspected at this location between 9 a.m. and 3 p.m., Monday through Friday, except Federal holidays. Comments may be submitted via fax to (425) 227-1232. Comments may also be sent via the Internet using the following address: 9-anm-iarcomment@faa.gov. Comments sent via fax or the Internet must contain “Docket No. 2003-NM-122-AD” in the subject line and need not be submitted in triplicate. Comments sent via the Internet as attached electronic files must be formatted in Microsoft Word 97 or 2000 or ASCII text.

The service information referenced in this AD may be obtained from Boeing Commercial Airplanes, Long Beach Division, 3855 Lakewood Boulevard, Long Beach, Calif. 90846, Attention: Data and Service Management, Dept. C1-L5A (D800-0024). This information may be examined at the FAA, Transport Airplane Directorate, 1601 Lind Avenue, SW., Renton, Wash.; or at the FAA, Los Angeles Aircraft Certification Office, 3960 Paramount Boulevard, Lakewood, Calif.; or at the Office of the Federal Register, 800 North Capitol Street, NW., Suite 700, Washington, D.C.

FOR FURTHER INFORMATION CONTACT: Mike S. Lee, Aerospace Engineer, Airframe Branch, ANM-120L, FAA, Los Angeles Aircraft Certification Office, 3960 Paramount Boulevard, Lakewood, Calif. 90712-4137; telephone (562) 627-5325; fax (562) 627-5210.

SUPPLEMENTARY INFORMATION: Five operators of McDonnell Douglas Model DC 9 81 (MD-81), DC-9-82 (MD-82), DC-9-83 (MD-83), DC-9-87 (MD-87), and Model MD 88 airplanes reported instances of a shock strut cylinder of a main landing gear (MLG) fracturing, resulting in the MLG collapse during landing roll out. The airplanes had a shock strut cylinder of the MLG that fractured after accumulating between a total of 6,386 and 28,100 landings. The fractures began at cracks on the outer surface of the cylinders. The cracks were created by high stresses from vibration that can occur during airplane braking. Failure of the shock strut cylinders of the MLGs due to cracking could lead to collapse of the MLGs and consequent reduced controllability of the airplane during landing.

Similar Condition Exists on Other Models

The shock strut cylinders on certain McDonnell Douglas Model MD-90-30 airplanes are identical to those on the affected Model DC-9-81 (MD-81), DC-9-82 (MD-82), DC-9-83 (MD 83), and DC-9-87 (MD-87) airplanes; and Model MD-88 airplanes. Therefore, those Model MD-90-30 airplanes may be subject to the unsafe condition due to exchanging a shock strut cylinder of a MLG from an affected airplane.

Related Rulemaking

AD 99-06-13, amendment 39-11077(64 FR 13330, Mar. 18, 1999), applicable to certain McDonnell Douglas Model DC-9-80 series airplanes; and Model MD-88 airplanes, requires repetitive inspections to detect fatigue cracking of the shock strut cylinder of the MLG and replacement of any cracked shock strut cylinder with a serviceable part. That AD references McDonnell Douglas Alert Service Bulletin MD80-32A286, Revision 03, dated May 28, 1998, as the applicable source of service information.

AD 96-01-09, amendment 39-9485(61 FR 2407, Jan. 26, 1996), applicable to certain McDonnell Douglas Model DC-9-80 series airplanes and Model MD-88 airplanes, requires installation of hydraulic brake line restrictors on the MLG, and modification of the hydraulic damper assembly of the MLG. That AD references McDonnell Douglas Service Bulletins MD80-32-276, dated Mar. 31, 1995, and Revision 1, dated Oct. 17, 1995; and MD80 32 278, dated Mar. 31, 1995, and Revision 1, dated Sep. 6, 1995; as the applicable sources of service information.

Explanation of Relevant Service Information

The FAA has reviewed and approved Boeing Alert Service Bulletin MD80-32A344, Revision 2, dated Jan. 28, 2004, for McDonnell Douglas Model DC-9-81 (MD-81), DC-9-82 (MD-82), DC-9-83 (MD-83), DC-9-87 (MD-87) airplanes; and Model MD-88 airplanes; and Boeing Alert Service Bulletin MD90-32A059, dated Jan. 28, 2004, for McDonnell Douglas Model MD-90-30 airplanes. These alert service bulletins specify verification of airplane records to determine service history of the shock strut cylinders of the MLGs. These alert service bulletins describe procedures for repetitive inspections (including performing fluorescent dye penetrant and fluorescent dry particle non-destructive testing) to detect cracking of the shock strut cylinders of the left and right MLGs, and replacement of any cracked shock strut cylinder with a new or serviceable part. Additionally, these alert service bulletins describe certain related investigative actions (such as chemically removing cadmium coating, and repeating the fluorescent dye penetrant and fluorescent magnetic particle non-destructive test inspections, if necessary).

Accomplishment of the actions specified in the alert service bulletins is intended to adequately address the identified unsafe condition.

Explanation of the Requirements of the Rule

Since an unsafe condition has been identified that is likely to exist or develop on other airplanes of the same type design registered in the United States, this AD is being issued to prevent failure of the shock strut cylinders of the MLGs due to cracking, which could result in collapse of the MLG and consequent reduced controllability during landing. This AD requires repetitive inspections to detect cracking of the shock strut cylinders of the left and right MLGs, and replacement of any cracked shock strut cylinder with a new or serviceable part. This AD also requires that, if a replacement shock strut cylinder is not new, the service history of the shock strut cylinder determines the applicability by Group definition in the applicable service bulletin described previously. This AD requires accomplishment of the actions specified in the alert service bulletins described previously, except as discussed below.

Differences between the Service Bulletins and the Airworthiness Directive

Although Boeing Alert Service Bulletin MD80-32A344, Revision 2, dated Jan. 28, 2004, specifies that McDonnell Douglas Alert Service Bulletin MD80-32A286, Revision 03, dated May 28, 1998, be accomplished prior to Boeing Alert Service Bulletin MD80-32A344, Revision 2, this AD does not require that action. As described in the “Related Rulemaking” section, accomplishment of Boeing Alert Service Bulletin MD80-32A286, Revision 03, is already required by AD 99-06-13.

Determination of Rule's Effective Date

Since a situation exists that requires the immediate adoption of this regulation, it is found that notice and opportunity for prior public comment hereon are impracticable, and that good cause exists for making this amendment effective in less than 30 days.

Comments Invited

Although this action is in the form of a final rule that involves requirements affecting flight safety and, thus, was not preceded by notice and an opportunity for public comment, comments are invited on this rule. Interested persons are invited to comment on this rule by submitting such written data, views, or arguments as they may desire. Communications shall identify the Rules Docket number and be submitted in triplicate to the address specified under the caption ADDRESSES. All communications received on or before the closing date for comments will be considered, and this rule may be amended in light of the comments received. Factual information that supports the commenter's ideas and suggestions is extremely helpful in evaluating the effectiveness of the AD action and determining whether additional rulemaking action would be needed.

Submit Comments using the Following Format:

Organize comments issue-by-issue. For example, discuss a request to change the compliance time and a request to change the service bulletin reference as two separate issues.

For each issue, state what specific change to the AD is being requested.

Include justification (e.g., reasons or data) for each request.

Comments are specifically invited on the overall regulatory, economic, environmental, and energy aspects of the rule that might suggest a need to modify the rule. All comments submitted will be available, both before and after the closing date for comments, in the Rules Docket for examination by interested persons. A report that summarizes each FAA-public contact concerned with the substance of this AD will be filed in the Rules Docket.

Commenters wishing the FAA to acknowledge receipt of their comments submitted in response to this rule must submit a self-addressed, stamped postcard on which the following statement is made: “Comments to Docket Number 2003-NM-122-AD.” The postcard will be date stamped and returned to the commenter.

Regulatory Impact

The regulations adopted herein will not have a substantial direct effect on the States, on the relationship between the national government and the States, or on the distribution of power and responsibilities among the various levels of government. Therefore, it is determined that this final rule does not have federalism implications under Executive Order 13132.

The FAA has determined that this regulation is an emergency regulation that must be issued immediately to correct an unsafe condition in aircraft, and that it is not a “significant regulatory action” under Executive Order 12866. It has been determined further that this action involves an emergency regulation under DOT Regulatory Policies and Procedures (44 FR 11034, Feb. 26, 1979). If it is determined that this emergency regulation otherwise would be significant under DOT Regulatory Policies and Procedures, a final regulatory evaluation will be prepared and placed in the Rules Docket. A copy of it, if filed, may be obtained from the Rules Docket at the location provided under the caption ADDRESSES.

List of Subjects in 14 CFR Part 39

Air transportation, Aircraft, Aviation safety, Incorporation by reference, Safety.

Adoption of the Amendment

Accordingly, pursuant to the authority delegated to me by the Administrator, the Federal Aviation Administration amends part 39 of the Federal Aviation Regulations (14 CFR part 39) as follows:

Part 39-Airworthiness Directives

1. The authority citation for part 39 continues to read as follows:

Authority: 49 U.S.C. 106(g), 40113, 44701.

§ 39.13 [Amended]

2. Section 39.13 is amended by adding the following new airworthiness directive:

Airworthiness Directive

Aircraft Certification Service

Washington, D.C. U.S. Department of Transportation

Federal Aviation Administration

We post ADs on the internet at “www.faa.gov”

The following Airworthiness Directive issued by the Federal Aviation Administration in accordance with the provisions of Title 14 of the Code of Federal Regulations (14 CFR) part 39, applies to an aircraft model of which our records indicate you may be the registered owner. Airworthiness Directives affect aviation safety and are regulations which require immediate attention. You are cautioned that no person may operate an aircraft to which an Airworthiness Directive applies, except in accordance with the requirements of the Airworthiness Directive (reference 14 CFR part 39, subpart 39.3).

2004-05-03 McDonnell Douglas: Amendment 39-13497. Docket 2003-NM-122-AD.

Applicability: Model DC-9-81 (MD-81), DC-9-82 (MD-82), DC-9-83 (MD-83), and DC-9-87 (MD-87) airplanes; and Model MD-88 airplanes; as listed in Boeing Alert Service Bulletin MD80-32A344, Revision 2, dated Jan. 28, 2004; and Model MD-90-30 airplanes, as listed in Boeing Alert Service Bulletin MD90-32A059, dated Jan. 28, 2004; certificated in any category. Compliance: Required as indicated, unless accomplished previously.

To prevent failure of the shock strut cylinders of the main landing gears (MLG) due to cracking, which could result in collapse of the MLG and consequent reduced controllability of the airplane during landing; accomplish the following:

Service Bulletin Reference

(a) The term “service bulletin,” as used in this AD, means the Accomplishment Instructions of the following service bulletins, as applicable:

(1) For Model DC-9-81 (MD-81), DC-9-82 (MD-82), DC-9-83 (MD-83), and DC-9-87 (MD-87) airplanes; and Model MD-88 airplanes: Boeing Alert Service Bulletin MD80-32A344, Revision 2, dated Jan. 28, 2004.

(2) For Model MD-90-30 airplanes: Boeing Alert Service Bulletin MD90-32A059, dated Jan. 28, 2004.

Records Verification

(b) For Group 1 airplanes as defined in the applicable service bulletin: Within 450 landings or 90 days after the effective date of this AD, whichever occurs first, perform a verification of airplane records to determine in which Group the airplane is specified (as defined in the applicable service bulletin). Per the applicable service bulletin, this verification is based on the service history of the shock strut cylinder of the MLG.

(1) If it can be positively verified from airplane records that the airplane is identified as a Group 2 airplane, per the applicable service bulletin, no inspections are required on that airplane.

(2) If it cannot be positively verified from airplane records that the airplane is identified as a Group 2 airplane, per the applicable service bulletin, the airplane is a Group 3 airplane, and the requirements of paragraph (c) of this AD must be accomplished at the time specified in paragraph (c) of this AD.

Inspections

(c) For Group 3 airplanes, as defined in the applicable service bulletin: Within 450 landings or 90 days after the effective date of this AD, whichever occurs first, do fluorescent dye penetrant and fluorescent magnetic particle non-destructive testing (NDT) inspections to detect cracking of the shock strut cylinders on the MLGs per the applicable service bulletin. Repeat the inspections of each shock strut cylinder thereafter at intervals not to exceed 450 landings on the shock strut cylinder.

Corrective Action

(d) For Group 3 airplanes as defined in the applicable service bulletin: Do the requirements of paragraph (d)(1), (d)(2), or (d)(3) of this AD at the times specified, per the applicable service bulletin.

(1) If a crack indication is not found by the inspections done per paragraph (c) of this AD, perform repetitive inspections as specified in paragraph (c) of this AD.

(2) If a crack indication is found, prior to further flight, do related investigative actions per the applicable service bulletin. If cracking is not confirmed, perform repetitive inspections as specified in paragraph (c) of this AD.

(3) If any cracking is confirmed per the investigative actions done in paragraph (d)(2) of this AD, prior to further flight, do paragraph (d)(3)(i) or (d)(3)(ii) of this AD.

(i) Replace the cracked shock strut cylinder with a serviceable shock strut cylinder, and do paragraph (b) of this AD.

(ii) Replace the affected left or right shock strut cylinder with a new shock strut cylinder, which constitutes terminating action for the repetitive inspection requirement in paragraph (c) of this AD for that shock strut cylinder.

Credit for Previous Service Bulletin Revision

(e) For Model DC-9-81 (MD-81), DC-9-82 (MD-82), DC-9-83 (MD-83), and DC-9-87 (MD-87) airplanes; and Model MD-88 airplanes: Accomplishment of the requirements of this AD prior to the effective date of this AD per Boeing Alert Service Bulletin MD80-32A344, dated Mar. 31, 2003; or Boeing Alert Service Bulletin MD80-32A344, Revision 1, dated Dec. 17, 2003; is considered acceptable for compliance with the initial inspection required in paragraph (c) of this AD, and/or replacement actions required by paragraph (d) of this AD, as applicable. The repetitive inspection interval remains 450 landings for the repetitive inspections.

Parts Installation

(f) As of the effective date of this AD, no person shall install on any airplane a shock strut cylinder of the MLG unless that part has been inspected and found to be crack-free, in accordance with the applicable service bulletin.

Alternative Methods of Compliance

(g) In accordance with 14 CFR 39.19, the Manager, Los Angeles Aircraft Certification Office, FAA, is authorized to approve alternative methods of compliance (AMOCs) for this AD.

Note 1: Information concerning the existence of approved AMOCs for this AD, if any, may be obtained from the Los Angeles ACO.

Incorporation by Reference

(h) Unless otherwise specified in this AD, the actions shall be done in accordance with Boeing Alert Service Bulletin MD80-32A344, Revision 2, dated Jan. 28, 2004; or Boeing Alert Service Bulletin MD90-32A059, dated Jan. 28, 2004; as applicable. This incorporation by reference was approved by the Director of the Federal Register in accordance with 5 U.S.C. 552(a) and 1 CFR part 51. Copies may be obtained from Boeing Commercial Airplanes, Long Beach Division, 3855 Lakewood Boulevard, Long Beach, Calif. 90846, Attention: Data and Service Management, Dept. C1-L5A (D800-0024). Copies may be inspected at the FAA, Transport Airplane Directorate, 1601 Lind Avenue, SW., Renton, Wash.; or at the FAA, Los Angeles Aircraft Certification Office, 3960 Paramount Boulevard, Lakewood, Calif.; or at the Office of the Federal Register, 800 North Capitol Street, NW., Suite 700, Washington, D.C.

Effective Date

(i) This amendment becomes effective on Mar. 15, 2004.

Issued in Renton, Wash., on Feb. 23, 2004.

Ali Bahrami,

Acting Manager, Transport Airplane Directorate, Aircraft Certification Service.

[FR Doc. 04-4475 Filed Feb. 26, 2004; 8:45 am]

BILLING CODE 4910-13-P

In association with the above noted airworthiness directive and further in providing an art enhancing methodology for inspecting aircraft for evidence of stress fracture and other external abnormalities, the instant invention discloses and claims a methodology in which paint and primer are removed in a designated “inspection area” of an aircraft component or external surface area to expose the surface to be inspected. A corrosion inhibiting compound (CIC) may be applied to the exposed inspection area. A “self-adhering” clear tape patch, larger than the inspection area and overlapping the surrounding paint by a designated margin is next installed over the inspection area. The patch protects the inspection area from corrosion and impact damage and as the tape patch is clear any underlying defects (corrosion, cracking, etc.) can be detected visually. The tape patch as utilized in the instant invention can be easily removed to facilitate repetitive inspections of the metal exposed in the inspection area. The need for repetitive inspections of the metal in the exposed inspection area is evidenced in the non-limiting adherence to Airworthiness Directive 2004-05-03 as described above.

### BRIEF SUMMARY OF THE INVENTION

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

In association with the above noted airworthiness directive and further in providing an art enhancing methodology for inspecting aircraft for evidence of stress fracture and other external abnormalities, the instant invention discloses and claims a methodology in which paint and primer are removed in a designated “inspection area” of an aircraft component or external surface area to expose the surface to be inspected. A corrosion inhibiting compound (CIC) is applied to the exposed inspection area. A “self-adhering” clear tape patch, larger than the inspection area and overlapping the surrounding paint by a designated margin is next installed over the inspection area. The patch protects the inspection are from corrosion and impact damage and as the tape patch is clear any underlying defects (corrosion, cracking, etc.) can be detected visually. The tape patch as utilized in the instant invention can be easily removed to facilitate repetitive inspections of the metal exposed in the inspection area. The need for repetitive inspections of the metal in the exposed inspection area is evidenced in the non-limiting adherence to Airworthiness Directive 2004-05-03 as described above.

Consequently, given the requirements of airworthiness directives and other concerns which require the repetitive inspection of aircraft surfaces, the present invention in one embodiment provides a methodology which enhances the prior art by disclosing and claiming a methodology which identifies an aircraft surface to be inspected, determines if the surface to be inspected is visually impeded by a coating compound selected from a group of compounds including paint topcoats and primers and if present, removing all visually impeding compounds. The invention next identifies and procures an adhesive tape patch with properties generally consistent of those demonstrated in 3M Product 8681HS Polyurethane Protective Tape and applies the adhesive patch over the inspected surface.

Given the deficiencies of the contemporary art with respect to inspecting and evaluating aircraft surfaces for stress factors and other surface abnormalities, the present invention discloses and claims a method of inspecting aircraft for evidence of stress fracture and other external abnormalities comprising:

(a) identify an aircraft surface to be inspected;

(b) determine if the surface to be inspected is visually impeded by a coating compound selected from the group of compounds including paint, topcoats, and primers;

(c) if present removing all visually impeding compounds identified in (b);

(d) when required, verifying the presence of cadmium plating in the area of the surface to be inspected;

(e) performing an inspection of the aircraft surface identified in (a);

(f) identifying and procure adhesive tape patch with properties generally consistent to those demonstrated in 3M product 8681 HS Polyurethane Protective Tape;

(g) when required, applying a corrosion inhibiting compound over the inspected surface area, subsequent to the surface's inspection; and,

(h) applying the adhesive patch of (e) over the inspected aircraft surface and corrosion inhibiting compound.

### BRIEF DESCRIPTION OF THE DRAWINGS

FIG. 1 is an illustration of the patch of the instant invention when applied according to the methodology associated with FIG. 2 upon an aircraft surface.

FIG. 2 is a non-limiting step and logic flow sequence of the methodology employed when practicing one embodiment of the present invention.

### DETAILED DESCRIPTION OF THE INVENTION

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

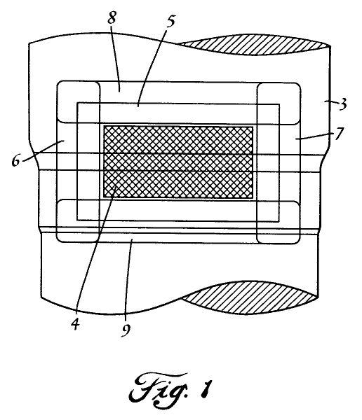

FIG. 1 an illustration of the patch of the instant invention. In FIG. 1 it is shown where an airplane surface (3) here a right-hand strut of the main landing gear of an MD-80 is shown with the Patch (5) of the instant invention applied. In this example of the patch application it is shown where a thin film of a corrosive inhibiting compound such as but not limited to Corban 27L, has been applied to the entire exposed surface of an inspection area. As described herein the surface area is defined with dimensions of approximately 2 inches in height by 4 inches in width; however, as will readily be appreciated by those skilled in the art, any appropriate dimensioning of an inspection area with complementary size dimensioning with respect to the patch of the instant invention may be facilitated in the practice of the invention. In FIG. 1 it is shown where Patch 5 overlays the previously applied corrosion inhibiting compound (4) and attributed to its self-adhering nature, conforms to the inspection area thus sealing or otherwise securing in place the corrosive inhibiting compound between the innermost surface of the patch and the exterior most or surface to be inspected of the aircraft (3). FIG. 1 further illustrates the optimal attachment of the patch to an airplane surface via an adhesive edge tape in simultaneous communication with one or more external portions of the adhesive patch (5) of the aircraft surface (3). In FIG. 1, the adhesive edge tape used to secure patch 5 to aircraft surface 3 are identified as edge tape surfaces 6, 7, 8 and 9. It has been shown through extensive experimentation that the overlapping upper 8, lower 9, first side 6 and second side 7 results in the most efficient and effective deployment of the edge tape surfaces in terms of further securing the self adhesive tape patch 5.

Two further observations have been had with respect to the application of the patch of FIG. 1 to the airplane surface. In extensive experimentation it has been shown that the tape patch with properties generally consistent to those demonstrated in 3M Product 8681 entitled HS Polyurethane Protective Tape will adhere adequately if the aircraft surface temperature is not below 70 degrees Fahrenheit. In the instance, the air temperature is less than 70 degrees Fahrenheit, or the aircraft surfaces has recently been exposed to temperatures below 70 degrees Fahrenheit, it has been shown that the use of heat lamps to preheat the aircraft surface where the tape will be applied is an efficient practice to utilize the methodology of the instant invention. Once the self adhesive patch has been installed it is further observed that continued heat application is recommended to insure the adhesive tape adheres adequately, but in no instance should the temperature at the inspected area surface be allowed to exceed 150 degrees Fahrenheit.

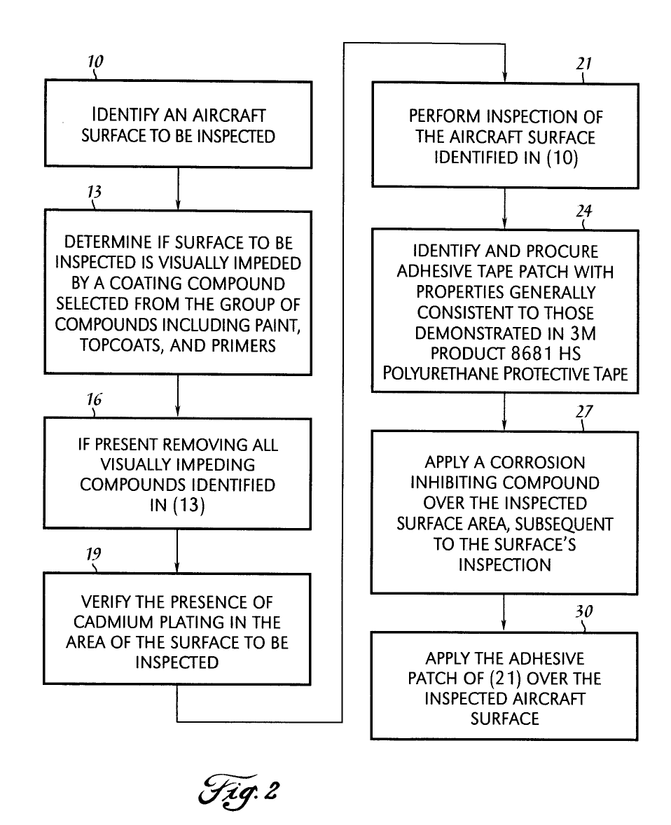

A second observation may be had with respect to applying the tape in that the tape should be applied deliberately to prevent wrinkling or introduction of bubbles. It is further observed that to prevent the corrosive inhibiting compound from traversing outwardly towards the edge of the patch, the center of the patch should not be depressed following application over the corrosive inhibiting compound. FIG. 2 discloses a non-limiting sequence of the invention's methodology with respect to deployment of the patch to effectuate its practice. Turning now to FIG. 2.

In FIG. 2 it is first required that an aircraft surface to be inspected be identified (10). As used throughout the present invention's disclosure for purposes of clarity and ease of understanding, an inspection area to be identified is synonymous with a 2 inch by 4 inch inspection area upon an aircraft surface (10). Once the identified area has been located, it is next determined if the surface to be inspected is visually impeded by a coating compound such as, but not limited to, paint, topcoats and primers (13). If present, the paint, topcoat and primer present over the inspection area should be removed (16). Such removal may be facilitated via the utilization of paint/primer stripping compounds or the “buffing” of the surface area or any other means which would allow the removal of such impeding compounds without damaging the underlying aircraft structure.

In some instances, particularly those instances mandated by the Federal Aviation Administration Authority via an Airworthiness Directive or other aircraft manufacturing directives, it may be necessary to verify the presence of cadmium plating in the area of the surface to be inspected (19). Once identified, the area to be inspected should be inspected via either a fluorescent dye penetrant inspection or independently or in combination with a fluorescent magnetic particle inspection of the aircraft surface (21). Said fluorescent dye penetrant inspections and fluorescent magnetic particle inspection processes are well-known and practiced by those skilled in the field. Other potential aircraft surface inspection procedures may include visual, eddy current, ultarasonic, radiographic or other known inspection methodologies practiced by those skilled in the art.

Assuming the area has been inspected and found to be deficient of any stress fractures or other abnormality posing threat to the integrity of the aircraft surface, an adhesive tape patch with properties generally consistent to those demonstrated in 3M Product 8681HS Polyurethane Protective Tape, must be procured (24). A corrosive inhibiting compound such as the CIC marketed under the COR-BAN 27L may be effectively used in association with practice of the instant invention's methodology; however, as will be readily apparent to those skilled in the art, other corrosive inhibiting compounds may be readily applied in lieu of the COR-BAN 27L product. Once the CIC has been applied to the inspected area (27), backing from the adhesive tape patch, if present, should be removed exposing a self adhesive surface. The patch is next carefully positioned over the center of the inspection area (reference FIG. 1), the patch must then be progressively pressed down on the surface starting at the top most surface and working down to the radius of the patch. At the radius, it is necessary to carefully conform the patch to the radius surface insuring no wrinkles or gaps. Continued application of pressure should be applied to the patch towards the bottom, stretching the patch toward the corners to insure a wrinkle and bubble-free installation. Additionally, a squeegee may be used to securely attach the patch edges to the aircraft surface. If desired, at this juncture edge tape may be applied via simultaneous communication with one or more external portions of the adhesive patch and airplane surface. Refer to Elements 6, 7, 8 and 9, FIG. 1. During periods of extensive experimentation it has been shown that a minimum of one hour must elapse subsequent to tape installation before operating the aircraft/aircraft surface in flight.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

What is claimed is:

1. A method of inspecting aircraft for evidence of stress fracture and other external abnormalities comprising:
(a) identifying an aircraft surface to be inspected;
(b) determining if the surface to be inspected is visually impeded by a coating compound selected from the group of compounds including paint, topcoats, and primers;
(c) if present removing all visually impeding compounds identified in (b);
(d) inspect the aircraft surface identified in (a);
(e) identify and procure adhesive tape patch with properties generally consistent to those demonstrated in 3M product 8681 HS Polyurethane Protective Tape; and,
(f) applying the adhesive patch of (e) over the inspected aircraft surface.

2. The method of claim 1 further comprising the verifying the presence of cadmium plating in the area of the surface to be inspected.

3. The method of claim 1 wherein applying the adhesive patch further comprises the attachment of the patch to an airplane surface via an adhesive edge tape in simultaneous communication with one or more external surface portions of the adhesive patch and an airplane surface.

4. The method of claim 1 further comprising application of a corrosion inhibiting compound over the inspected surface area, subsequent to inspection and in advance of applying the adhesive patch.

5. The method of claim 1 wherein the inspection of the aircraft surface further comprises performing a fluorescent dye penetrant inspection.

6. The method of claim 1 wherein the inspection of the aircraft surface further comprises performing a fluorescent magnetic particle inspection.

7. The method of claim 1 wherein the inspection of the aircraft surface further comprises performing a fluorescent dye penetrant inspection and a fluorescent magnetic particle inspection.

8. The method of claim 1 wherein the inspection of the airplane surface is selected from the group of inspection processes including, visual, eddy, current, ultrasonic, and radiographic inspection processes.

9. A method of inspecting aircraft for evidence of stress fracture and other external abnormalities comprising:
(a) identify an aircraft surface to be inspected;
(b) determine if the surface to be inspected is visually impeded by a coating compound selected from the group of compounds including paint, topcoats, and primers;
(c) if present removing all visually impeding compounds identified in (b);
(d) verify the presence of cadmium plating in the area of the surface to be inspected;
(e) perform a fluorescent dye penetrant inspection and a fluorescent magnetic particle inspection of the aircraft surface identified in (a);
(f) identify and procure adhesive tape patch with properties generally consistent to those demonstrated in 3M product 8681 HS Polyurethane Protective Tape;
(g) apply a corrosion inhibiting compound over the inspected surface area, subsequent to the surface's inspection;
(h) apply the adhesive patch of (f) over the inspected aircraft surface and corrosion inhibiting compound.

10. The method of claim 9 further comprising verifying the presence of cadmium plating in the area of the surface to be inspected.

11. The method of claim 9 wherein applying the adhesive patch further comprises the attachment of the patch to an airplane surface via an adhesive tape in simultaneous communication with one or more external surface portions of the adhesive patch and an airplane surface.

12. The method of claim 1 wherein the aircraft surface to be inspected is identified on a Boeing 737 aircraft.

13. The method of claim 1 wherein the aircraft surface to be inspected is identified on a Boeing 757 aircraft.

14. The method of claim 1 wherein the aircraft surface to be inspected is identified on a Boeing 767 aircraft.

15. The method of claim 9 wherein the aircraft surface to be inspected is identified on a Boeing 737 aircraft.

16. The method of claim 9 wherein the aircraft surface to be inspected is identified on a Boeing 757 aircraft.

17. The method of claim 9 wherein the aircraft surface to be inspected is identified on a Boeing 767 aircraft.

18. The method of claim 1 wherein the surface to be inspected is a surface identified on an aircraft selected from the group of aircraft including:
Canadair CL-600
Embraer ERJ-135, -145, -170, -175, -190
Boeing 707, 717, 727, 737, 747, 757, 767, 777, 787
McDonnell-Douglas DC-8, DC-9, DC-10, MD-80, MD-11, MD-90;
Airbus A300, A310, A318, A319, A320, A321, A330, A340, A380; and
Fokker F70, F100 aircraft.

19. The method of claim 9 wherein the surface to be inspected is a surface identified on an aircraft selected from the group of aircraft including:
Canadair CL-600;
Embraer ERJ-135, -145, -170, -175, -190;
Boeing 707, 717, 727, 737, 747, 757, 767, 777, 787;
McDonnell-Douglas DC-8, DC-9, DC-10, MD-80, MD-11, MD-90;
Airbus A300, A310, A318, A319, A320, A321, A330, A340, A380; and
Fokker F70, F100 aircraft.

20. The method of claim 1 further comprising the removal of an adhesive tape patch with properties generally consistent to those demonstrated in 3M product 8681 HS Polyurethane Protective Tape prior to inspecting the aircraft surface.

21. The method of claim 9 further comprising the removal of an adhesive tape patch with properties generally consistent to those demonstrated in 3M product 8681 HS Polyurethane Protective Tape prior to inspecting the aircraft surface.

22. The method of claim 1 wherein the inspection of the airplane surface is selected from the group of inspection processes including, visual, eddy, current, ultrasonic, and radiographic inspection processes.
